(19) United States
(12) Patent Application Publication
(10) Pub. No.: US 2004/0257346 A1
(43) Pub. Date: Dec. 23, 2004

(54) Content selection and handling

(75) Inventors: Jay Ong, Kirkland, WA (US); Cory Linton, Kirkland, WA (US); Stan Leszynski, Issaquah, WA (US); Ron Stephens, Seattle, WA (US); Kollen Glynn, Newcastle, WA (US); Jeff Rubingh, Shoreline, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/465,796

(22) Filed: Jun. 20, 2003

(51) Int. Cl. G09G 5/00

(52) U.S. Cl. 345/179

(57) ABSTRACT

A system and process for selecting content and performing an action associated with the content is described. One may use a stylus to indicate what content is to be captured. One may perform a number of actions on the content including emailing, printing, coping to a clipboard, and the like. The system provides for the capture to be started, controlled, and acted upon in a simple, intuitive manner.

### BACKGROUND OF THE INVENTION

1. Field of the Invention

Aspects of the present invention relate to image processing and information manipulation. More specifically, aspects of the present invention relate to capturing and handling displayed content.

2. Description of Related Art

People often rely on graphical representations more than textual representations of information. They would rather look at a picture than a block of text that may be equivalent to the picture. For instance, a home owner may cut out pictures of magazines to show contractors exactly what is desired when remodeling a kitchen or bathroom. Textual representations of the same material often fall short. The tool that the home owner may use is no more complex than a pair of scissors.

In the computing world, however, attempting to capture and convey the identical content is cumbersome. Typical computer systems do not provide an easy interface for capturing and conveying graphically intensive content. Rather, they are optimized for capturing and rendering text. For instance, typical computer systems, especially computer systems using graphical user interface (GUI) systems, such as Microsoft WINDOWS, are optimized for accepting user input from one or more discrete input devices such as a keyboard for entering text, and a pointing device such as a mouse with one or more buttons for driving the user interface.

Some computing systems have expanded the input and interaction systems available to a user by allowing the use of a stylus to input information into the systems. The stylus may take the place of both the keyboard (for data entry) as well as the mouse (for control). Some computing systems receive handwritten electronic information or electronic ink and immediately attempt to convert the electronic ink into text. Other systems permit the electronic ink to remain in the handwritten form.

Despite the existence of a stylus, selection of displayed content remains difficult and cumbersome. One needs to copy a screen to a paint program, crop the information, and then forward the information as one desires. However, this process can become difficult with a stylus.

One company, TechSmith Corporation, has introduced Snagit®, a product for capturing screens. Snagit® is mouse-based and requires multiple steps prior to capturing content. These steps detract from the usefulness and ease of capturing content. Accordingly, a simple capturing process is needed for capturing and handling content using a stylus.

### BRIEF SUMMARY

Aspects of the present invention address one or more of the issues mentioned above, thereby providing a better content capture and annotation system. Aspects of the present invention include a process for designating content to be captured and providing that content to another application. In at least one aspect, the content capturing process may include the use of a pen in a pen-based computing system and using the pen to allow freeform designation of content to be captured.

These and other aspects are addressed in relation to the Figures and related description.

### BRIEF DESCRIPTION OF THE DRAWINGS

The present invention is illustrated by way of example and not limited in the accompanying figures in which like reference numerals indicate similar elements and in which:

FIG. 1 shows a general-purpose computer supporting one or more aspects of the present invention.

FIG. 2 shows a display for a stylus-based input system according to aspects of the present invention.

FIG. 3 shows an illustrative interface for activating one aspect of the present invention.

FIG. 4 shows an illustration of the designation of content and an annotation in accordance with aspects of the present invention.

FIG. 5 shows various operations that may be performed on designated content in accordance with aspects of the present invention.

FIG. 6 shows the processing of designated content in accordance with aspects of the present invention.

FIGS. 7 and 8 shows various processes that may be used with aspects of the present invention.

FIGS. 9-11 show various processes for capturing content in accordance with aspects of the present invention.

FIG. 12 shows a state diagram in accordance with aspects of the present invention.

### DETAILED DESCRIPTION OF THE DRAWINGS

Aspects of the present invention relate to capturing information in a region designated by a stylus in simple, intuitive steps. In one aspect of the present invention, a user may initiate a capture process, capture content, and then perform an action on the content. The action may include, but is not limited to, the following:

Emailing;

printing;

copying to a clipboard;

saving;

annotating (including adding handwritten ink and/or highlighting various portions of the captured content);

erasing some or all of the captured content;

selecting some or all of the captured content;

opening an editor to further modify the captured content; and,

terminating the process.

This document is divided into sections to assist the reader. These sections include: characteristics of ink, terms, general-purpose computing environment, and content capture and use.

Characteristics of Ink

As known to users who use ink pens, physical ink (the kind laid down on paper using a pen with an ink reservoir) may convey more information than a series of coordinates connected by line segments. For example, physical ink can reflect pen pressure (by the thickness of the ink), pen angle (by the shape of the line or curve segments and the behavior of the ink around discreet points), and the speed of the nib of the pen (by the straightness, line width, and line width changes over the course of a line or curve). Because of these additional properties, emotion, personality, emphasis and so forth can be more instantaneously conveyed than with uniform line width between points.

Electronic ink (or ink) relates to the capture and display of electronic information captured when a user uses a stylus-based input device. Electronic ink refers to a sequence of strokes, where each stroke is comprised of a sequence of points. The points may be represented using a variety of known techniques including Cartesian coordinates (X, Y), polar coordinates (r, Θ)), and other techniques as known in the art. Electronic ink may include representations of properties of real ink including pressure, angle, speed, color, stylus size, and ink opacity. Electronic ink may further include other properties including the order of how ink was deposited on a page (a raster pattern of left to right then down for most western languages), a timestamp (indicating when the ink was deposited), indication of the author of the ink, and the originating device (at least one of an identification of a machine upon which the ink was drawn or an identification of the pen used to deposit the ink) among other information.

Terms

Ink—A sequence or set of strokes with properties. A sequence of strokes may include strokes in an ordered form. The sequence may be ordered by the time captured or by where the strokes appear on a page or in collaborative situations by the author of the ink. Other orders are possible. A set of strokes may include sequences of strokes or unordered strokes or any combination thereof. Further, some properties may be unique to each stroke or point in the stroke (for example, pressure, speed, angle, and the like). These properties may be stored at the stroke or point level, and not at the ink level

Ink object—A data structure storing ink with or without properties.

Stroke—A sequence or set of captured points. For example, when rendered, the sequence of points may be connected with lines. Alternatively, the stroke may be represented as a point and a vector in the direction of the next point. In short, a stroke is intended to encompass any representation of points or segments relating to ink, irrespective of the underlying representation of points and/or what connects the points.

Point—Information defining a location in space. For example, the points may be defined relative to a capturing space (for example, points on a digitizer), a virtual ink space (the coordinates in a space into which captured ink is placed), and/or display space (the points or pixels of a display device).

General-Purpose Computing Environment

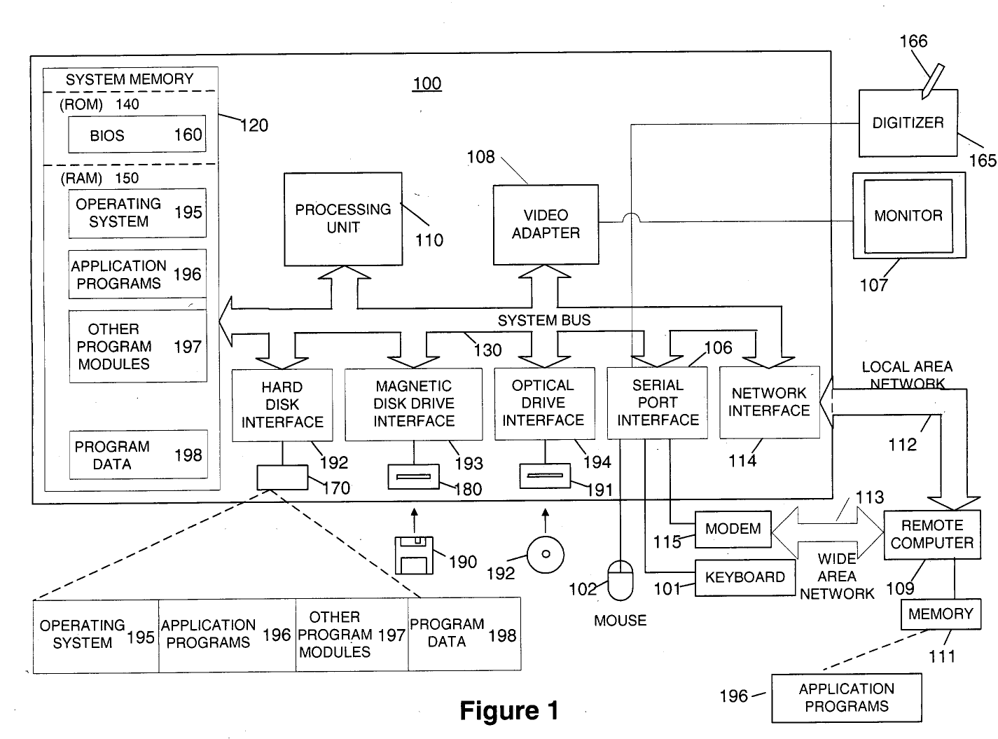

FIG. 1 illustrates a schematic diagram of an illustrative conventional general-purpose digital computing environment that can be used to implement various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). [at this point in time, since USB is so popular, you might want to feature USB in FIG. 1] Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers. In one embodiment, a pen digitizer 165 and accompanying pen or stylus 166 are provided in order to digitally capture freehand input. Although a direct connection between the pen digitizer 165 and the serial port interface 106 is shown, in practice, the pen digitizer 165 may be coupled to the processing unit 110 directly, parallel port or other interface and the system bus 130 by any technique including wirelessly. Also, the pen 166 may have a camera associated with it and a transceiver for wirelessly transmitting image information captured by the camera to an interface interacting with bus 130. Further, the pen may have other sensing systems in addition to or in place of the camera for determining strokes of electronic ink including accelerometers, magnetometers, and gyroscopes.

Furthermore, although the digitizer 165 is shown apart from the monitor 107, the usable input area of the digitizer 165 may be co-extensive with the display area of the monitor 107. Further still, the digitizer 165 may be integrated in the monitor 107, or may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device. Further, the system may include wired and/or wireless capabilities. For example, network interface 114 may include Bluetooth, SWLan, and/or IEEE 802.11 class of combination abilities. It is appreciated that other wireless communication protocols may be used in conjunction with these protocols or in place of these protocols.

It will be appreciated that the network connections shown are illustrative and other techniques for establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

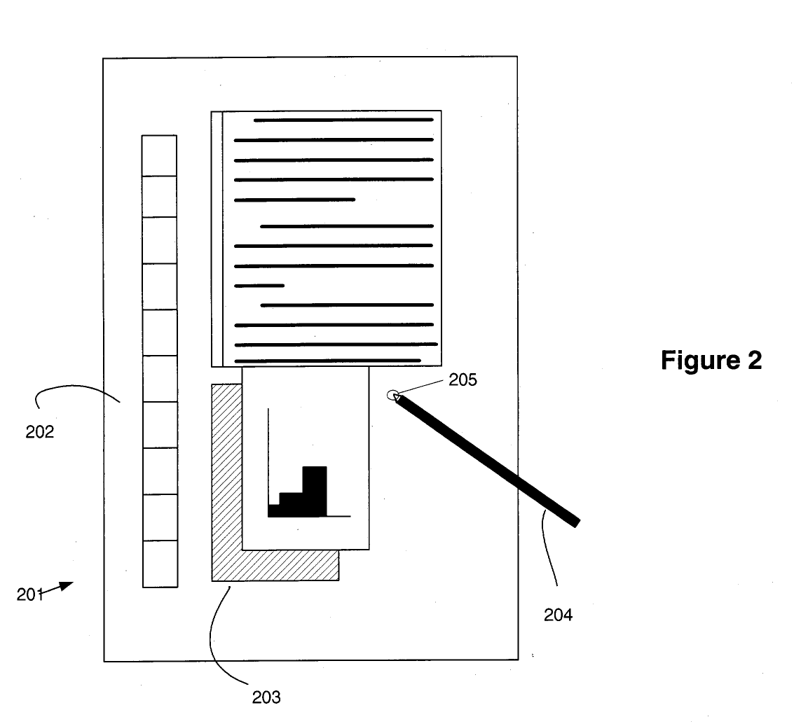

FIG. 2 illustrates an illustrative tablet PC 201 that can be used in accordance with various aspects of the present invention. Any or all of the features, subsystems, and functions in the system of FIG. 1 can be included in the computer of FIG. 2. Tablet PC 201 includes a large display surface 202, e.g., a digitizing flat panel display, preferably, a liquid crystal display (LCD) screen, on which a plurality of windows 203 is displayed. Using stylus 204, a user can select, highlight, and/or write on the digitizing display surface 202. Examples of suitable digitizing display surfaces 202 include electromagnetic pen digitizers, such as Mutoh or Wacom pen digitizers. Other types of pen digitizers, e.g., optical digitizers, may also be used. Tablet PC 201 interprets gestures made using stylus 204 in order to manipulate data, enter text, create drawings, and/or execute conventional computer application tasks such as spreadsheets, word processing programs, and the like.

The stylus 204 may be equipped with one or more buttons or other features to augment its selection capabilities. In one embodiment, the stylus 204 could be implemented as a “pencil” or “pen”, in which one end constitutes a writing portion and the other end constitutes an “eraser” end, and which, when moved across the display, indicates portions of the display are to be erased. Other types of input devices, such as a mouse, trackball, or the like could be used. Additionally, a user's own finger could be the stylus 204 and used for selecting or indicating portions of the displayed image on a touch-sensitive or proximity-sensitive display. Consequently, the term “user input device”, as used herein, is intended to have a broad definition and encompasses many variations on well-known input devices such as stylus 204. Region 205 shows a feedback region or contact region permitting the user to determine where the stylus 204 as contacted the display surface 202.

In various embodiments, the system provides an ink platform as a set of COM (component object model) services that an application can use to capture, manipulate, and store ink. One service enables an application to read and write ink using the disclosed representations of ink. The ink platform may also include a mark-up language including a language like the extensible markup language (XML). Further, the system may use DCOM as another implementation. Yet further implementations may be used including the Win32 programming model and the Net programming model from Microsoft Corporation.

Content Capture and Handling

One of the benefits of a stylus-based computing system is the closeness it brings a user to interacting with printed paper. Instead of being separated from by a keyboard and mouse, a stylus-based computer permits a user to more intimately interact with a document and displayed content as easily as one would interact with physical paper. One may use the application with an electromagnetic digitizer, may use a resistive touch screen or the like. The application may use functionality provide with ink (strokes, properties, methods, events, and the like) or may rely on bit mapped images of ink encircling content.

As to capturing and sending content, conventional image capturing tools require significant interaction between the user and the capturing application to specify which type of capturing process is desired and navigation of distracting menus to indicate how the content is handled, even before content is captured.

Aspects of the present invention attempt to eliminate these distractions by making content capturing and handling more intuitive. In one aspect, the system may allow initiation of the capture process, capture, and initiation of an action associated with captured content with three clicks or taps of the stylus.

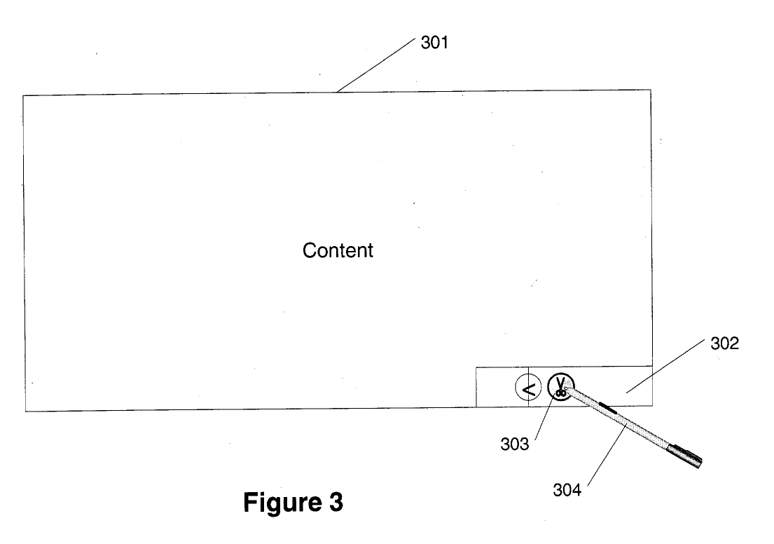

FIG. 3 shows an example of how one may activate the content capture aspect of the present invention. A display on a user's computer is shown as region 301. Region 301 includes content that a user may wish to capture. A user may locate region 302 which includes at least one button 303. Upon selection of the button 303 with stylus 304, content capture aspect of the present invention may be initiated. It is appreciated that other techniques may be used to activate content capture application including, but not limited to, a gesture of the stylus 304, tapping on a button not in region 302, clicking of a button on stylus 304, pressing a hardware button on keyboard or a computer's case, and the like. Further, aspects of the present invention may be accessible through application programming interfaces called by another application.

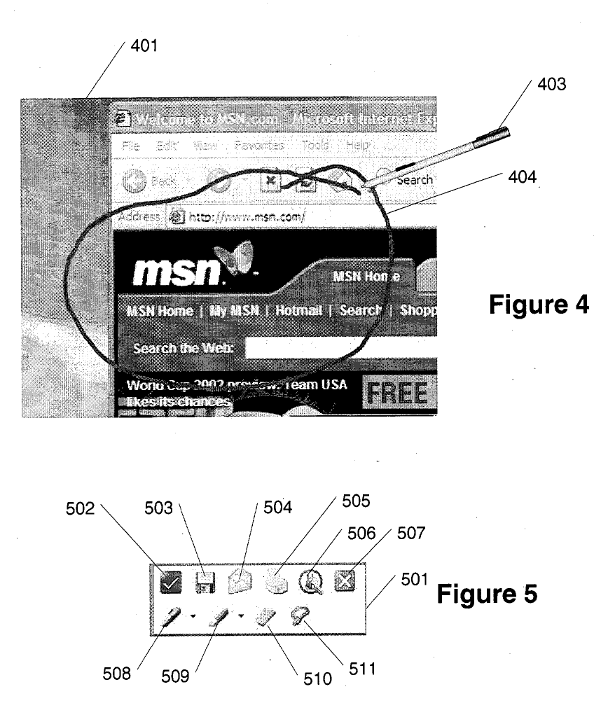

FIG. 4 shows the designation of content in accordance with aspect of the present invention. Content is displayed in region 401. A user wants to capture content in the vicinity of content 402. A user may use stylus 403 to encircle content 402 by using stylus 403. To provide the user with an indication of the content as being selected, the system may display the track of stylus 403 as path 404. Path 404 may be displayed as thick or thin, opaque ink. Alternatively, path 404 may be displayed as translucent ink so as to permit a user to see the content 402 beneath the ink. Further, path 404 may not be displayed as a boundary, but rather may separate various levels of shading to distinguish selected region 402 from on selected regions. The system may determine the selection of region 402 based on the completion of a closed shape made by the stylus 403. Alternatively, the system may determine the selection based on content partially encircled by the stylus 403 and drawing a connecting line between the stylus' current position and the position where the stylus was first placed on the screen.

FIG. 5 shows a number of tools available on a toolbar 501. Toolbar 501 may appear after ink path 404 is complete. Alternatively, toolbar 501 may appear after stylus 403 has been lifted off the display. Further, toolbar 501 may appear based on a gesture or click of a button on stylus 403.

Toolbar 501 includes a number of options that may be used with designated content 402. For instance, a user may copy designated content 402 to a clipboard upon selection of a first button 502. A user may save the content of region 402 by selection of button 503. A user may e-mail the content of region 402 upon selection of button 504. The email feature permits users to easily share information by emailing the captured image and any annotation, or by copying it to a clipboard so that it can be pasted into another program.

A user may print the content of region 402 upon selection of button 505. Upon selection of button 506, the system may open a content selection editor where the content of designated region 402.

Upon selection of button 508, the user may be able to change a pen width and/or color of the ink. Using the pen functionality of button 508, the user may then annotate the captured content as simply as annotating on a piece of paper. Upon selection of button 509, the user may be able to change the pen width of a highlighter and/or color of the highlighter. Users may write words, circle objects, highlight objects (with, for instance, subtractive rendering so that the object below can be seen through the highlighting or with opaque ink), and effectively do anything else akin to annotating a piece of paper with a pen.

Upon selection of button 510, the user may erase some or all of the content in region 402. Upon selection of button 511, the user may operate a selection tool to further select some or all of the content of region 402. Finally, upon selection of button 507, the tool bar 501 and region 402 may be closed.

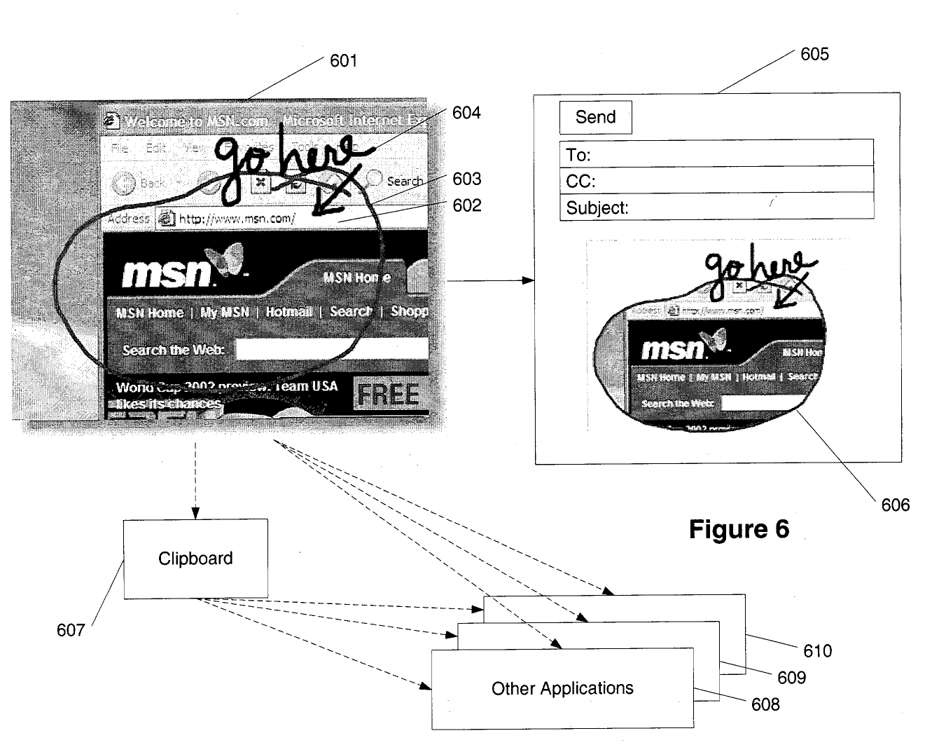

FIG. 6 shows the processing of designated content in accordance with aspects of the present invention. A region 601 includes designated content 602, border 603 which defines the shape of content 602, and an annotation 604. The designated content with additional information (optional, but shown here as border 603 and annotation 604) may be forwarded to an email client (for instance) for handling. Here, as shown by draft email 605, the content 602 and optional additional information may be provided in the email as 606 or may be included as an attachment. Other actions may be performed on content 602. For instance, the content 602 may be copied to a clipboard 607, and then forwarded to other applications 608-610. Alternatively, content 602 may be forwarded directly to other applications 607-609.

The content captured by aspects of the present invention may include static content (for example, images) or underlying data. For instance, underlying text (for example, HTML links, words, sentences, and/or paragraphs) may be captured. Also, underlying objects (for instance, stock tickers, calendars, files being displayed or played) and underlying associations with remote content (for instance, the location of a music file being played locally) may be captured. Further, meta-data including the person capturing the information, the date and time capture may be associated with the captured information as well. The source of the content may be identified as well.

More than one region may be selected. For instance, by holding down a button (performing a gesture or the like) one may designate that additional content should be selected. In this regard, one may have another gesture or a button act as the indication that all desired content has been selected.

Aspects of the present invention may be implemented as a stand-alone application. Alternatively, aspects of the present application may be incorporated into a shell providing a graphical user interface to a user. In one example, the capturing tool may be integrated into an internet browser.

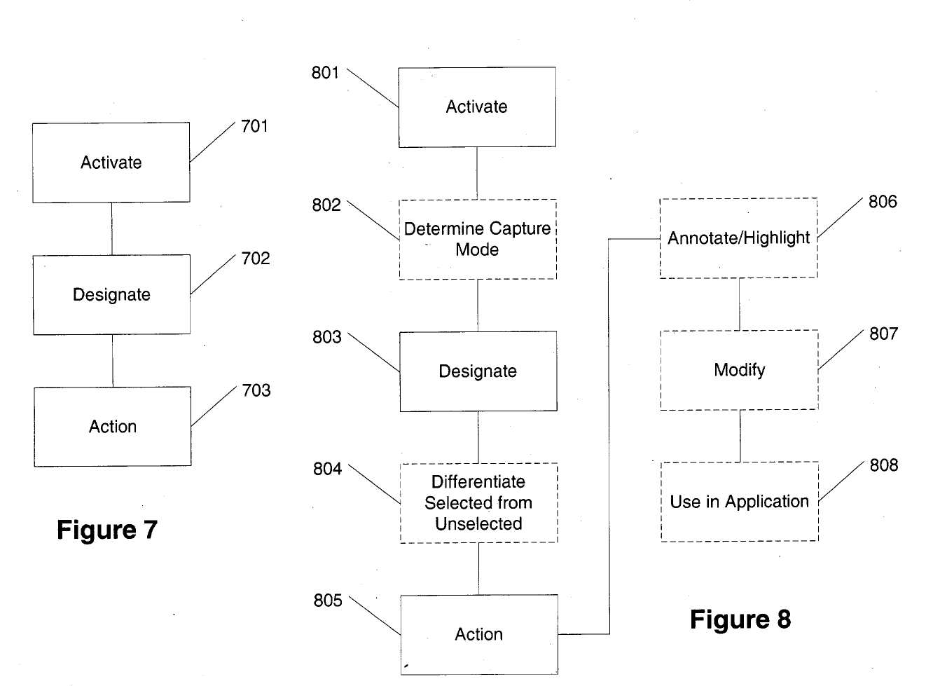

FIGS. 7 and 8 shows various processes that may be used with aspects of the present invention. FIG. 7 shows three steps used in the capturing and handling process. In one embodiment, each step in FIG. 7 is tied to the tap of a stylus against a display. Alternatively, at least some may be tied to the tap of a button on the display, pressing a hardware button, or the click of a button on the stylus. For instance, upon a first tap of a stylus, the capturing process may be activated in step 701. On the second tap, or pen down action, the content to be selected may be designated. In one example, the pen may start inking around the content, leaving a border 603 as shown in FIG. 6. Upon a pen up event, or when the border 603 is closed around content, the designation step 702 may end. At a third tap, for example, on displayed tool bar 501, designates the action 703 that the user wants to occur on the designated content.

In one example, the activation of the content capture tool in step 701 may be the clicking of an icon in a system tray. At that point, the entire screen may become an inkable surface. In step 702, the captured region that is surrounded by ink may be defined by a colored ink boundary. Upon a pen up event (or other gesture or clicking another region or button) in step 702, a tool bar 501 may be shown. The presence of the toolbar permits the next step 703 to be easily selected by the user. Of course, toolbar 501 may always be present or may appear immediately after step 701 is initiated. The optional gesture as described with relation to step 702 may, for instance, be a small circle or other gesture where the amount enclosed by the ink is small or duplicative of what has already been captured.

FIG. 8 shows an alternative version of FIG. 7 with additional optional steps. In step 801, the user activates the data capturing process. In step 802, the system determines the data capturing mode. This may be done based on the position of the stylus, the region encircled, and other factors. In step 803, the user designates the content. In step 804, the system differentiates between the selected and the unselected regions. This may be done based on color changes, shading changes, blinking areas, and the like. In one instance, the entire screen may be darkened by a percentage (for example, 5-50%) and the selected region illuminated back to the screen's original brightness. Alternatively, the screen may remain at its original brightness and the selected region darkened. Color shifts or changes may also be used to differentiate the selected regions from the unselected regions.

In step 805, an action is performed. Next, the action may lead to the creation of an annotation or highlight in step 806. The action may lead to modification of the selected region in step 807. Further, the action may lead to the use in an application (email, a spreadsheet, a word processor, a web drafting tool, a graphic editing tool, a database, a XML assembly tool that relates to the content and the like.

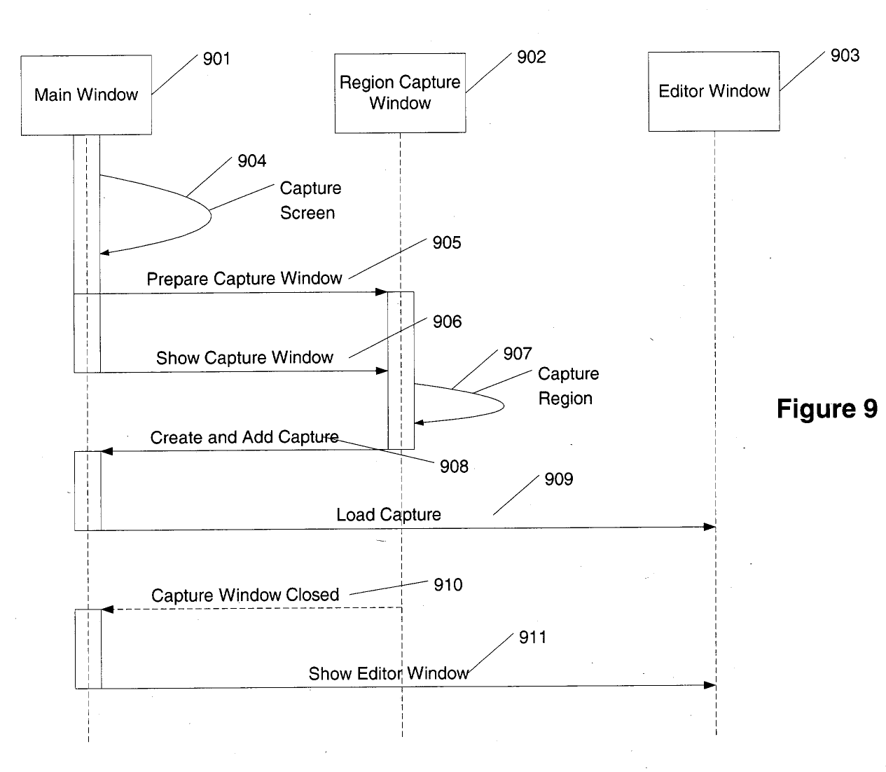

FIGS. 9-11 show various processes for capturing content in accordance with aspects of the present invention.

FIG. 9 shows an illustrative process for handling a request for capturing a displayed region in accordance with aspects of the present invention using, for instance, an editor. It is appreciated that the process shown in FIG. 9 is but one example of the process for capturing and reflecting this capture process to a user. Other processes may be used without departing from the scope of the invention.

A main window is shown as 901, the region capture window as 902, and an editor window 903. The system receives a request to capture a region or screen in step 904. Next, in step 905, the system prepares the region capture window 902.

First, the system may ensure that any of the windows relating to the selection of the capture region or screen in step 904 are minimized and that any windows underneath those windows have been repainted. For instance, this may be performed by enumerating the top level windows and forcing them to refresh.

Next, once the windows have been repainted, a snapshot may be captured of the current desktop.

Next, the desktop image may be used to construct a shaded image dimmed by a predetermined percentage (for instance, 5-50%), which becomes the background of the capture window. In one example, to obtain a shading of 15%, the system may apply a 4×4 color matrix with the upper left to lower right diagonal of 0.85, 0.85, 0.85 and 1. The shaded image may or may not exclude the Windows taskbar and may be sized according to a working area of the desktop. The dimming may gradually increase in size as the stylus is moved.

Next, the background of the capture window may be set to the shaded image giving the illusion that the desktop has been dimmed.

Finally, a copy of the un-faded image that included the taskbar may be also passed to the capture window for later use.

In step 906, the capture window is shown. The capture window may have the following attributes:

Opaque background. This prevents the system from painting the background and causing a flash effect. Since the entire background may be covered by the shaded image in the foreground, the need to paint the background is eliminated.

To simulate the desktop, the window may be shown maximized without borders. In order to not obscure the Windows taskbar, the window size is set to the system's working area (which may not include the taskbar).

Next, in step 907, the capture region is defined by the user. For instance, the region may be defined as follows:

a. The user uses the stylus to encircle a region of the screen in one continuous stroke (pen down to pen up).

b. The first point of the region is stored and used to determine if the point is part of a browser window and thus derive the current hyperlink of that window. The process for determining hyperlink information is as follows:

i. Obtain the handle of the next window below the current capture window.

ii. Walk down the z-order list of windows, testing for the first visible window that contains the point.

iii. If a window is found, enumerate the list of browser windows looking for a matching handle.

iv. If a match is found, the point is contained within a browser window.

v. Extract the hyperlink address and title of the browser window.

c. The stroke may be tagged so that it can be erased as with normal ink strokes.

d. The individual polygonal points that make up the stroke are translated to the point (0, 0) and converted into screen coordinates for creating various temporary images.

e. The selected region is highlighted (un-dimmed) for visual feedback to the user. The process for doing this may be as follows:

i. A temporary image is created from the original un-faded image passed to the window, corresponding to the same section of the screen as the captured region. The image is cropped to the size of the captured region.

ii. This image is used as input into a texture brush to create a second temporary image of the same size with just the interior of the region filled with the screen background texture.

iii. Finally a new faded background is created with a ‘lit’ section by using a texture brush with the second temporary image to draw over the faded image of the screen. Even though the texture brush of the lit section is created from the original un-faded screen image that includes the taskbar, the bounds of the faded image are used instead to create an un-faded section that excludes the taskbar.

Next, in step 908, the system creates a new window and adds the new captured content to the new window in main window 901.

In step 909, the new captured content is loaded into the editor window 903. The capture window is closed in step 910. The editor window is shown to the user in step 911.

The user may annotate over the screen including outside the original captured region. Once the user chooses to save the capture, the system may create a new capture region as follows:

a. An in-memory representation of the capture is made from the region image (obtained from the second temporary image, see step 907, e(ii)), the upper-left screen coordinate of the rectangular bounds of the image (location), the annotated ink strokes, the associated hyperlink information (if any) and a flag indicating whether the capture stroke should be visible.

The capture may be displayed on-screen by drawing the associated ink strokes over the top of the captured image at the stored location.

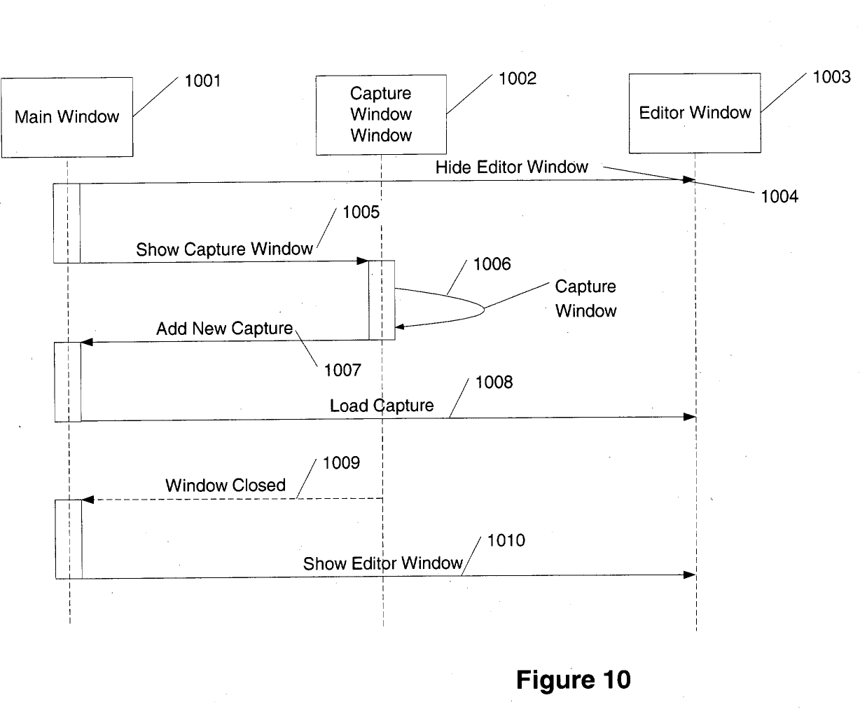

FIG. 10 shows an illustrative process for capturing a window. A main window 1001, a ‘capture window’ window is shown as 1002, and an editor window is shown as 1003.

First, in step 1004, the editor window is hidden. Next, in step 1005, the system shows the capture window.

The ‘capture window’ window may be a top most, maximized, borderless window with a high transparency (for instance, 98% transparency). It may overlie the desktop and may be invisible to the user. Windows are highlighted as the stylus cursor moves over them using the following process:

a. For each visible window that is not the capture window, test if the cursor position is contained within the window bounds.

b. If it is and it is a different window than was previously highlighted, highlight the window's frame by painting it (for example, using an inverse raster operation). Repaint the previous window by performing the same operation, thus inverting back to normal.

c. Update and store the current and previous window handles for future comparison.

In step 1006, a window is captured. A window may be captured by using a window handle stored in the current window variable when the stylus touches the screen (pen down). Depending on user options, an image may be taken of the window that includes any other windows in front of, and contained within the desired window's bounds or of only the actual window regardless of regions obscured by other windows or positioned outside the current view port.

Window captures may be created using the same process as stated previously using the window image but with no capture stroke or annotations. A hyperlink may be obtained using the following process:

a. Enumerate the list of browser windows looking for a handle that matches the currently selected window handle.

b. If a match is found, the current window is a browser window.

c. Extract the hyperlink address and title of the browser window.

Once a window is selected, a new capture may be created as follows:

a. An in-memory representation of the capture is made from the window image, the point (0, 0), the size of the image, and any associated hyperlink information.

Next, in step 1007, the new capture window is added to the main window 1001. In step 1008, the capture content is loaded into editor window 1003. In step 1009, the ‘capture window’ window is closed. In step 1010, the editor window is showed to the user.

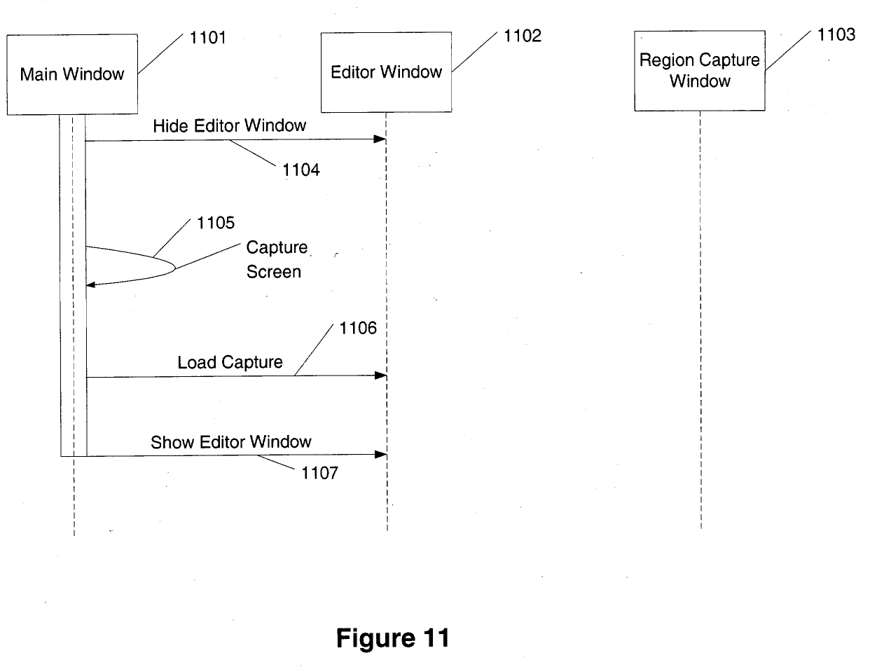

FIG. 11 shows a process for capturing a screen and loading it into an editor window. A main window is shown as 1101, an editor window as 1102, and a region capture window 1103.

First, in step 1104, the editor window is hidden. Next, in step 1105, a screen is captured. In step 1106, the captured content is loaded into the editor 1102. Finally, the editor window is shown in step 1107.

This process may use the standard Windows BitBlt API to capture the displayed screen. From this structure, the application may create a capture using a process similar to that in step 1006 described above.

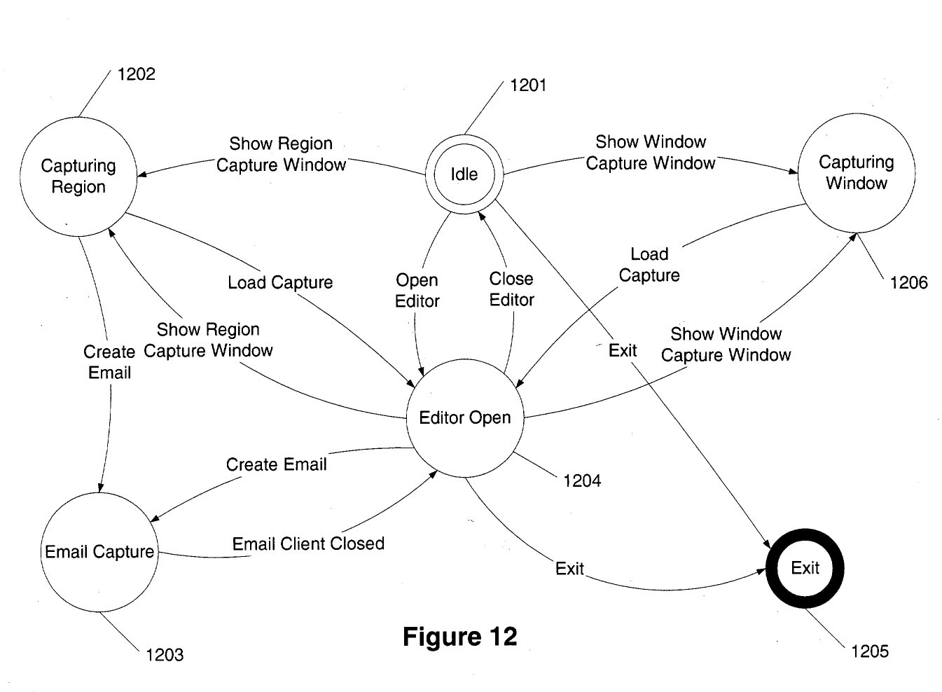

FIG. 12 shows a state diagram in accordance with aspects of the present invention. The system may be idle in step 1201. A number of events may cause the system to move from idle state 1201. A show region capture window event may cause the system to change to capturing region state 1202. A show window capture window may cause the system to change to a capturing window state 1206 (for instance, though interaction with a menu or the like). An open editor event may cause the system to move to the editor open state 1204. An exit event may change the state to the exit state 1205 where the system exits.

From capturing region state 1202, a create mail event may change to the email capture state 1203. A load capture event may change the state to editor open state 1204.

From the capturing window state 1206, a load capture event may change the state to editor open state 1204.

From the editor open state 1204, a close editor event may change the state to the idle state 1201. A create email event may change the state to the email capture state 1203. A show region capture window event may change the state to the capturing region state 1202. A show window capture window event may change the state to the capturing window state 1206. An exit event may change the state to the exit state 1205.

From the email capture state 1203, an email client closed event may change the state to the editor open state 1204.

It is appreciated that some of the states may be removed for various applications. For instance, if no window capturing ability exists, and then state 1206 may be removed. Likewise, various other states may be removed as well.

The application may be constructed using any of a variety of languages including C++, C#, and other languages. The application may be an extensible application created as a .NET application in accordance with the .NET structure of the Microsoft Corporation. The application may be constructed using a variety of different approaches. One is shown below as an illustration. It is appreciated that alternative approaches may be used.

For example, the application may include four forms as part of the C# infrastructure. The four forms may include a main form, a capture region form, an editor window form, and a capture region form.

For instance, the main form may be an entry point for the application. The main form may ensure that there is only one instance of the application running at any one time. The main form may serve as a controller for coordinating the other primary forms that make up the application. It also may serve as a container for the notification icon in the system tray and may house the handlers for a context menu of an icon related to the application. This form may not be visible to the user.

Different implementations may include or eliminate the main form. One advantage of including the main form is to have the separate invisible main form house the notification icon in the system tray and direct the rest of the application. This inclusion reduces the overall complexity and allows cleaner coordination of the application.

When included, the main form may act as a central controller for the application. As a result, other forms like the two capture forms and the editor form do not ‘talk’ to each other directly; they are coordinated through the main form. All other primary forms contain a reference to the main form but not to each other.

In one embodiment, the region capture form, the capture window form and the editor form may appear in some degree on screen at the same time. Alternatively, they may be may be mutually exclusive from each other and be controlled to not appear on the screen at the same time. They may be mutually exclusive in this respect and the main form may coordinate their appearance.

To ensure that all windows are current before any capturing begins, the windows may be repainted using a window repainting method. For instance, using Win32, one may call the UpdateWindow method for at least each top level window. Alternatively, one may add a delay in the capture utility in the hope that at least the top level windows are refreshed.

Next, the capture region form may be the form used to capture freehand regions drawn with the stylus or pen. This form may contain the toolbar as shown in FIG. 501 that gives the user access to features like email, copy-to-clipboard, and enables annotation of the a previously designated region on the screen.

Starting a freehand region capture with the stylus may be done from within the editor or from a context menu displayed upon activation of icon 303. The icon may not change to indicate the content capturing process has begun. Alternatively, the icon may blink (for instance, at a rate of 500 ms) to indicate that the content capturing process is active. This may or may not be combined with the optional process of fading/shading/coloring the screen to show the capturing process has begun.

The capture region form may be a topmost, maximized, borderless window with a fill-docked InkPicture control. A ‘feature’ of maximized, borderless windows is that they completely cover the screen including the taskbar. In one instance, the task bar may be included in the region capable of being captured. Alternatively, the taskbar may be excluded from the capturable region as this ensures access to the taskbar (in a Windows® environment) to remain unimpeded. This may be set by setting a maximized bounds property of the capture region form.

So as to allow the region capture form to capture content, the main form may capture the current screen and provide at least one copy to the region capture form. For instance, two copies may be provided: one faded and one not faded. The region capture form may then use faded copy to set the image property of an ink picture control and may store the un-faded copy for later use.

When the user draws a stroke to designate content (which may also be referred to as a capture stroke), the stroke may be tagged using an extended property so that it can be removed from any subsequent annotation strokes being selected or deleted. The bounding rectangle of the region the user captured may be translated to the un-faded, stored image of the desktop and the un-faded section used in a texture brush to create a new faded desktop image with a non-faded section. It is this non-faded section that may be used to create the actual captured content.

If the first point of the capture stroke is made on top of a web browser control, the control's hyperlink may also be captured. This may be performed by drilling down through the list of windows and looking for the first visible window underneath the capture form that contains the point. This window is then matched against the collection of browser windows and if a match is found, the hyperlink information is extracted. Similarly, the underlying text or control in a region may be extracted as well.

The capture region form's control may have one or more toolbars associated with it. Also, optionally, to avoid a flash the first time the form is shown and the control painted, the form may be double buffered.

The editor form may support the various features shown in tool bar 501. The editor form may be opened in several ways including but not limited to: from the notification icon's context menu, from the capture region window's on-screen toolbar or by opening a capture file with extension that corresponds to an extension associated with captured content.

The editor form may include a main menu, at least two toolbars (regular and ink), and a panel containing various controls. Also, one may use a variety of techniques to convert captured images into bitmaps or other image formats. For instance, one may use an object that renders the captured image in a desired format. Alternatively, one may use DIB sections from a graphics buffer.

A control associated with taking the ink defined region may optionally include additional functionalities including expanding/contracting and undo/redo features. This may permit the extensibility of the application.

The application may include undo and redo logic. For instance, when the size of the captured image may be expanded to include any additional annotations created by a user. This may include using an extended property feature of strokes to tag the strokes that were associated with a particular undo/redo item on the stack. This may permit an identification of which were the last deposited ink strokes and undo/redo them accordingly. Using this process, one may undo and redo the following: strokes, deletions, moves, resizes, cuts and pastes.

Finally, the capture window form may be used to capture an entire window. Annotations may be made in the editor or directly. Capturing windows may follow a similar implementation of in the main form. Here, the form may be maximized. Next, the user may tap the window to be captured.

For instance, the opacity of the window may be changed to permit capture of stylus taps. To designate a window, the border of the window may be highlighted. Alternatively, one may invert various windows when the stylus is positioned over them. Finally, the captured portions of the windows may or may not include the entire window (as some windows may be moved partially off screen or be behind other windows). This means that in one instance, only the viewable part of a window is captured. In another instance, more than the viewable part of a window is captured.

Various applications may be used additionally to handle captured content. For instance one may email or print the designated content, among other options. Also, one may have content (from any source) and push it into the editor to add annotations.

As to emailing the content, the content may be sent through a mail client or may be sent through a mail client embedded within another application (for instance, in a word processing application).

As to printing the content, one may print the content as easily as one prints graphical images.

The capture content may or may not be stored as a collection. For instance, one may store the captured content in an accessible collection in which various annotations to a similar content or set of content may be opened as a whole. So, for instance, all annotations made to a web page (though with different actual portions of the web page having been captured) may be opened at the same time.

Aspects of the present invention have been described in terms of illustrative embodiments thereof. Numerous other embodiments, modifications and variations within the scope and spirit of the appended claims will occur to persons of ordinary skill in the art from a review of this disclosure.

We claim:

1. A computer system for capturing content comprising:
a display that displays content of which at least some of the content is to be captured;
a stylus-based input device that designates a freeform boundary that designates said at least some of the content to be captured; and,
a processor that receives input from said stylus-based input device, determines said at least some of the content to be captured, and associates said at least some of the content with another application.

2. The system according to claim 1, wherein said another application includes an email client.

3. The system according to claim 1, wherein said another application includes a clipboard.

4. The system according to claim 1, wherein said another application includes a word processing application.

5. The system according to claim 1, wherein said another application includes an instant messaging application.

6. A process for capturing and annotating content comprising the steps of:
designating content to be captured using a stylus;
annotating said designated content; and,
forwarding said designated content to another application.

7. The process according to claim 6, wherein said designating content step includes designation of a freeform boundary between said designated content and non-designated content.

8. The process according to claim 6, wherein said annotating step includes highlighting.

9. The process according to claim 6, wherein said annotating step includes cropping.

10. A process for capturing and forwarding content comprising the steps of:
designating content to be captured using a stylus, said designated content having a freeform border; and,
forwarding said designated content to another application.

11. The process according to claim 10, wherein said designating content step includes designation of a freeform boundary between said designated content and non-designated content.

12. The process according to claim 10, further comprising the step of annotating said content.
